(19) United States
(12) Patent Application Publication
(10) Pub. No.: US 2020/0338730 A1
(43) Pub. Date: Oct. 29, 2020

(54) TRAJECTORY PLANNING DEVICE, TRAJECTORY PLANNING METHOD AND PROGRAM

(71) Applicant: Hitachi, Ltd., Tokyo (JP)

(72) Inventors: Yuta YAMAUCHI, Tokyo (JP); Nobuaki NAKASU, Tokyo (JP)

(21) Appl. No.: 16/843,990

(22) Filed: Apr. 9, 2020

(30) Foreign Application Priority Data
Apr. 25, 2019 (JP) 2019-084367

(51) Int. Cl. B25J 9/16

(52) U.S. Cl. CPC B25J 9/1664; B25J 9/1666; B25J 9/1651; B25J 9/1605; B25J 9/1612

(57) ABSTRACT

A trajectory planning device calculating the trajectory of the robot arm reads robot arm configuration information including a configuration of the robot arm, and a position and a posture of an axis configuring a joint, start joint angle information, target posture information, and via-point posture information in which via points including positions and postures through which the hand of the robot arm passes are set, and generates a trajectory from a start point of the hand of the robot arm to an end point by an interpolation between via points, calculates a joint angle of each axis from a posture and a position of the hand of the robot arm based on the robot arm configuration information, converts the trajectory generated in a physical space into a joint angle space by an inverse kinematics unit, and then smooths the trajectory.

### CLAIM OF PRIORITY

The present application claims priority from Japanese patent application JP 2019-084367 filed on Apr. 25, 2019, the content of which is hereby incorporated by reference into this application.

### TECHNICAL FIELD

The present invention relates to a trajectory planning technique for a multi-axis robot arm.

### BACKGROUND ART

PTL 1 is known as a background art in the present technical field. PTL 1 discloses that “However, in a case of an example in the related art, since an operation direction changes suddenly when passing through a via teaching point, a large acceleration may occur at the via teaching point. As a result, there is a possibility that a vibration is caused, a required accuracy cannot be obtained, or an excessive force is applied, thereby causing a damage to a transfer object or a machine body such as a wafer or a glass substrate. The invention has been made to solve the above problems, and an object thereof is to provide a control device or the like that can smoothly change a velocity even when a manipulator is moved according to the via teaching point set in consideration of disturbance.”

### CITATION LIST

### Patent Literature

PTL 1: JP-A-2014-104558

### SUMMARY OF INVENTION

### Technical Problem

PTL 1 describes a method for calculating a trajectory connecting curve interpolation points such that a start teaching point, a target teaching point, and the via teaching points are input, and the trajectory passes through the curve interpolation points defined on line segments respectively connecting the start teaching point, the via teaching points, and the target teaching point. However, when a control method of PTL 1 is applied to the multi-axis robot arm, all the teaching points need to be input with a joint angle value of each axis or a hand posture, so that the following problems are caused.

Although all the teaching points are certainly connected smoothly in a joint angle space when being specified by a joint angle of each axis, a user needs to input any one of a plurality of joint angles realizing the same hand posture. Thus, there is a problem that the hand posture may greatly change on the trajectory depending on an input teaching point.

On the other hand, when all the teaching points are determined by the hand posture, although a hand moves smoothly, since a change of the joint angle of each axis may increase near the curve interpolation points, there is a problem that an operation of the robot arm becomes slow due to a limitation of an angular velocity or an angular acceleration of each axis of the robot arm. That is, in the control method of PTL 1, there is a case where it is impossible to obtain the trajectory on which the robot arm operates at a high velocity while minimizing the change in the hand posture.

Therefore, the invention provides a device which realizes a smooth movement of a hand posture by inputting a via point and a target point in the hand posture, smooths a joint angle change by introducing smoothing processing in a joint angle space during path planning, and therefore outputs a trajectory on which the robot arm operates at a high velocity while minimizing a change in the hand posture of the robot arm.

### Solution to Problem

According to the invention, there is provided a trajectory planning device that includes a processor and a memory, and calculates a hand trajectory of a robot arm configured with multiple axes according to the invention. The trajectory planning device includes robot arm configuration information including a configuration of the robot arm, and a position and a posture of an axis configuring a joint of the robot arm, start joint angle information in which an angle of each axis of the robot arm in a start posture of a planned trajectory is set as a start joint angle, target posture information in which a target position and a target posture of a hand of the robot arm are set at an end of the hand of the robot arm, posture information in which via points including positions and postures through which the hand of the robot arm passes in the planned trajectory are set, an inter-via-point trajectory planning unit in a physical space configured to read the robot arm configuration information, the start joint angle information, the target posture information and the via-point posture information, and generate a trajectory from a start point of the hand of the robot arm to the end point by interpolating between the via points, an inverse kinematics unit configured to calculate a joint angle of each axis from a posture and a position of the hand of the robot arm based on the robot arm configuration information, and a joint angle space trajectory smoothing unit configured to convert the trajectory generated by the inter-via-point trajectory planning unit into a physical space in a joint angle space by the inverse kinematics unit and smooth the trajectory.

### Advantageous Effect

According to the invention, it is possible to provide a device that calculates a trajectory on which a robot arm can move at a high velocity through a plurality of via points while minimizing a change in a hand posture.

Problems, configurations and effects other than the above will be apparent with reference to description of the following embodiments.

### BRIEF DESCRIPTION OF DRAWINGS

FIG. 1 is a block diagram showing an example of a configuration of a trajectory planning device for a multi-axis robot arm according to an embodiment of the invention.

FIG. 2 is a flowchart showing an example of processing performed by the trajectory planning device according to the embodiment of the invention.

FIG. 3 is a diagram showing an example of robot arm configuration data according to the embodiment of the invention.

FIG. 4 is a diagram showing an example of interferer configuration data according to the embodiment of the invention.

FIG. 5 is a diagram showing an example of start joint angle data according to the embodiment of the invention.

FIG. 6 is a diagram showing an example of target posture data according to the embodiment of the invention.

FIG. 7 is a diagram showing an example of via-point posture data according to the embodiment of the invention.

FIG. 8 is a diagram showing an example of trajectory interpolation method data according to the embodiment of the invention.

FIG. 9 is a diagram showing an example of trajectory data according to the embodiment of the invention.

FIG. 10 is a flowchart showing an example of processing executed by an inter-via-point trajectory planning unit in a physical space performed in step S103 of FIG. 2 according to the embodiment of the invention.

FIG. 11 is a flowchart showing an example of processing executed by a joint angle space trajectory smoothing unit performed in step S104 of FIG. 2 according to the embodiment of the invention.

FIG. 12 is a diagram showing an example of an output screen according to the embodiment of the invention.

FIG. 13 is a diagram showing an example of a trajectory of the robot arm according to the embodiment of the invention.

FIG. 14 is a diagram showing an example of a result of performing a trajectory plan in a partial trajectory according to the embodiment of the invention.

FIG. 15 is a diagram showing an example of a trajectory in a joint angle space using information on whether smoothing is possible according to the embodiment of the invention.

FIG. 16 is a diagram showing an example of a hand trajectory in a physical space according to the embodiment of the invention.

FIG. 17 is a diagram showing an example of a hand trajectory smoothed in the joint angle space according to the embodiment of the invention.

### DESCRIPTION OF EMBODIMENTS

Embodiments will be described below with reference to the drawings. It should be noted that in all the drawings for describing the embodiments, the same components are denoted by the same reference numerals in principle, and a repetitive description thereof will be omitted. In this embodiment, an example of a trajectory planning device which is a basic embodiment of the invention will be described.

<System Configuration>

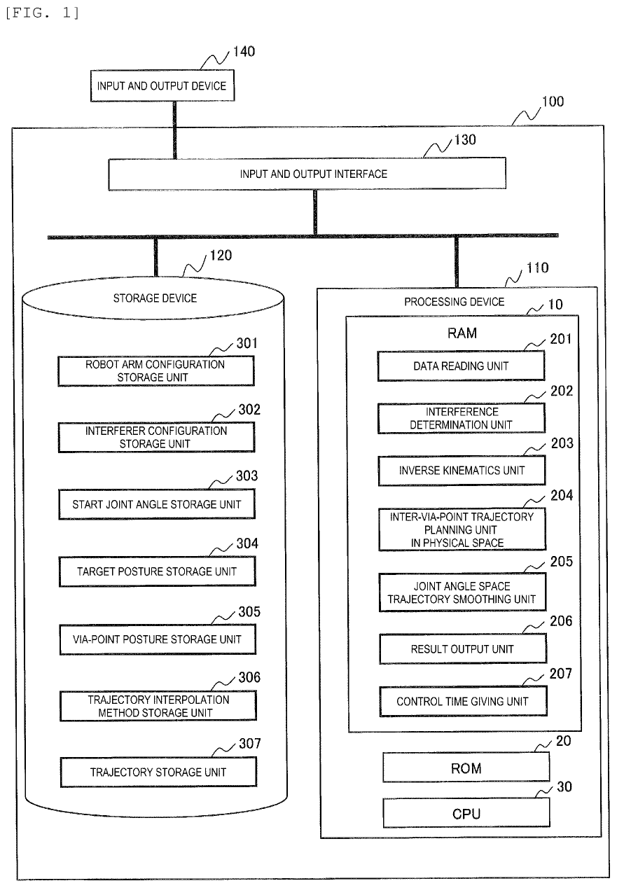

FIG. 1 is a block diagram showing a computer system to which the invention is applied, showing a configuration example including a trajectory planning device 100 for a robot arm and peripheral devices. An entire computer system includes the trajectory planning device 100 and an input and output device 140. A user uses functions of the trajectory planning device 100 through an operation of the input and output device 140. The trajectory planning device 100 can be configured with a computer (PC, server, or the like), and realizes a function (each processing unit of a processing device 110) which is a feature of the invention by, for example, software program processing.

The trajectory planning device 100 includes the processing device 110, a storage device 120, an input and output interface 130, or the like.

The input and output device 140 is an input device for inputting measurement data or the like and an output device for outputting a reference shape allocation result or the like by a user operation and includes, for example, a keyboard, a mouse, a display, a printer, a smartphone, a tablet PC, or the like.

The input and output interface 130 is a component that performs interface control (peripheral device control) processing such as data exchange with the input and output device 140. The computer system provides a graphical user interface (GUI) and displays various types of information on a screen of the input and output device 140 based on processing of the processing device 110 and processing of the input and output interface 130.

The processing device 110 includes, for example, known or well-known components such as a CPU 30, a RAM 10, and a ROM 20. The processing device 110 is a component that performs processing for realizing a characteristic function of the invention, and includes a data reading unit 201, an interference determination unit 202, an inverse kinematics unit 203, an inter-via-point trajectory planning unit in a physical space 204, a joint angle space trajectory smoothing unit 205 and a result output unit 206.

Although not shown, the trajectory planning device 100 includes known components such as an OS, middleware, and an application, and particularly includes an existing processing function for displaying a GUI screen on the input and output device 140 such as a display. The processing device 110 performs processing of drawing and displaying a predetermined screen, processing on data input by the user on the screen, or the like using the above processing functions.

Each functional unit of the data reading unit 201, the interference determination unit 202, the inverse kinematics unit 203, the inter-via-point trajectory planning unit in a physical space 204, the joint angle space trajectory smoothing unit 205 and the result output unit 206 is loaded into the RAM 10 as a program.

The CPU 30 operates as a functional unit that provides a predetermined function by executing the processing according to the program of each functional unit. For example, the CPU 30 functions as the interference determination unit 202 by executing the processing according to an interference determination program. The same applies to other programs. Further, the CPU 30 also operates as a functional unit that provides respective functions of a plurality of kinds of processing executed by each program. The computer and the computer system are an apparatus and a system including these functional units.

The storage device 120 is configured with a known or well-known nonvolatile storage medium such as an HDD or an SSD, and includes a robot arm configuration storage unit 301, an interferer configuration storage unit 302, a start joint angle storage unit 303, a target posture storage unit 304, a via-point posture storage unit 305, a trajectory interpolation method storage unit 306, and a trajectory storage unit 307. Each storage unit includes, for example, a database or a table.

The robot arm configuration storage unit 301 is an area for storing robot arm configuration data 401 used in a trajectory plan, inverse kinematics, or the like.

The interferer configuration storage unit 302 is an area for storing interferer configuration data 402 used for an interference determination performed in the trajectory plan.

The start joint angle storage unit 303 is an area for storing start joint angle data 403 serving as a start point in the trajectory plan. A joint angle indicates an angle around a joint axis of the robot arm. Alternatively, the angle may be formed by a pair of links connected to the axis.

The target posture storage unit 304 is an area for storing target posture data 404 serving as an end point in the trajectory plan.

The via-point posture storage unit 305 is an area for storing via-point posture data 405 serving as a via point in the trajectory plan.

The trajectory interpolation method storage unit 306 is an area for storing trajectory interpolation method data 406 used when planning a trajectory between via points.

The trajectory storage unit 307 is an area for storing trajectory data 407 output by the result output unit 206.

In this embodiment, a structure or a shape of the robot arm is not specified. For example, an example is assumed in which a six-axis robot arm grips an object with a manipulator at a hand (tip). The robot arm may be multi-axial, and axes (joints) are arranged in series and connected by links. The tip of the robot arm is not limited to the manipulator, and can be configured with a tool or a machine such as a driver or a welding device.

In this embodiment, the trajectory or the via point is configured with a position and a posture at the hand of the robot arm. The position at the hand of the robot arm indicates a position of an axis at the tip among a plurality of axes constituting the robot arm. The posture at the hand of the robot arm indicates an angle (joint angle) of the axis at the tip among the plurality of axes constituting the robot arm. In the following description, a description of a position or a posture of the robot arm indicates the position and the posture at the hand of the robot arm.

<Flowchart>

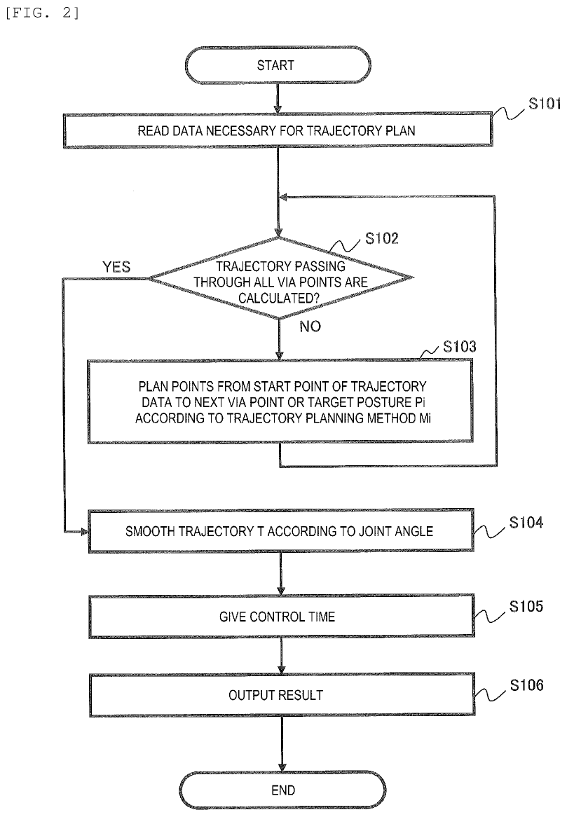

FIG. 2 is a flowchart showing an example of a trajectory planning process. Contents of each step of this flowchart will be described with reference to FIGS. 13, 14, 15, and 16. In the following description, each functional unit is described as a subject of the processing, but the CPU 30 may be the subject of the processing as described above. This processing is started, for example, when the user of the trajectory planning device 100 inputs a predetermined command from the input and output device 140.

In step S101, based on information input by the user through the input and output device 140, the data reading unit 201 stores the robot arm configuration data 401 in the robot arm configuration storage unit 301, stores the interferer configuration data 402 in the interferer configuration storage unit 302, stores the start joint angle data 403 in the start joint angle storage unit 303, stores the target posture data 404 in the target posture storage unit 304, stores the via-point posture data 405 in the via-point posture storage unit 305, and stores the trajectory interpolation method data 406 in the trajectory interpolation method storage unit 306.

In this embodiment, although it is assumed that the user inputs the above data via the input and output device 140, data that has already been generated, including past input data, may be read into the processing device 110.

Input data in this step will be described with reference to FIG. 13. FIG. 13 is a diagram showing an example of the input data, and is a diagram showing the trajectory on an X-Y plane in a real space (physical space) where the robot arm operates.

In the X-Y plane, P1 is set as the start joint angle data, and P5 is set as target data. P2, P3, and P4 are set as the via-point posture data on the way from P1 to P5.

As a trajectory interpolation method, it is assumed that information (P1, P2, straight line (Straight), no smoothing (Smoothing=False)), (P2, P3, curve, smoothing), (P3, P4, curve, smoothing), (P4, P5, straight line, no smoothing) is given. In this example, a goal is to make the trajectory plan when the hand of the robot arm moves from P1 to P5 via P2, P3, and P4.

In the illustrated example, a trajectory in a section from the point P1 to the point P2 is treated as a partial trajectory T1, and partial trajectories T2 to T4 are similarly set between other via points. In this embodiment, adjacent postures IDs 451 in the via-point posture data 405 are treated as one partial trajectory Ti.

In step S102, the inter-via-point trajectory planning unit in a physical space 204 acquires the trajectory data 407 stored in the trajectory storage unit 307, and determines whether the stored trajectory has already reached the target posture data 404. The inter-via-point trajectory planning unit in a physical space 204 proceeds to step S104 when the trajectory passing through all the via points are calculated, and proceeds to step S103 when there is an unprocessed section.

In step S103, the inter-via-point trajectory planning unit in a physical space 204 uses necessary data stored in the storage device 120 to calculate the partial trajectory according to a format of the trajectory data 407, and adds the partial trajectory to the trajectory data 407 stored in the trajectory storage unit 307. Details of step S103 will be described later.

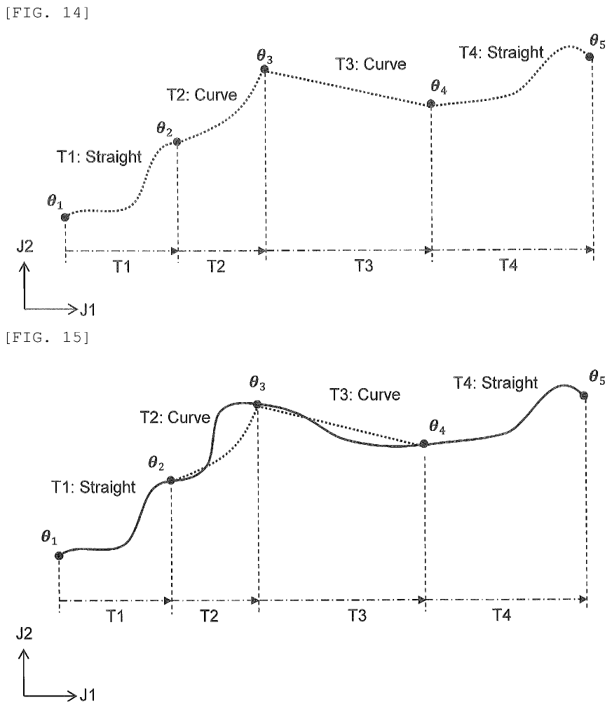

An output in step S103 will be described with reference to FIG. 14. FIG. 14 is a result of displaying a result of performing the trajectory plan on each partial trajectory with respect to an input shown in FIG. 13 in a joint angle space of the robot arm.

For example, a straight trajectory (Straight) is assigned in the physical space shown in FIG. 13 with respect to the partial trajectory T1 (P1, P2), and in order to realize the straight trajectory, the trajectory becomes like a curve connecting θ1 and θ2 in the joint angle space.

The same applies to the other partial trajectories, and in many robot arms, even when a hand trajectory is a curve or a straight line in the physical space, the trajectory is not the same in the joint angle space. Even when the hand is moving along a smooth line in the physical space, there is also a case where the connection cannot be smoothly performed due to a via posture or the like in the joint angle space.

FIG. 14 shows an example in which an axis J1 is disposed on a horizontal axis, and an axis J2 is disposed on a vertical axis in the joint angle space. The joint angle space is a multidimensional space corresponding to the number of axes of the robot arm. For example, the joint angle space is represented by six dimensions of axes J1 to J6 in a case of the six-axis robot arm.

In step S104, the joint angle space trajectory smoothing unit 205 corrects the trajectory data 407 by applying the smoothing to the trajectory data 407 stored in the trajectory storage unit 307 in the joint angle space. Details of step S104 will be described later.

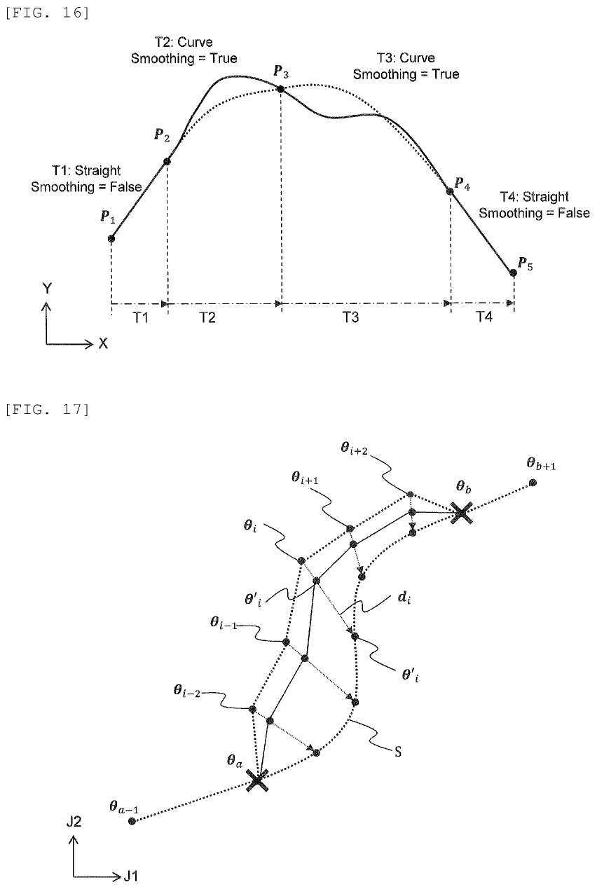

An overview of the processing in step S104 will be described with reference to FIGS. 15 and 16. As shown in FIG. 14, when a plurality of trajectories are connected, there is a case where the connection cannot be smoothly performed in the joint angle space. In step, a processing for connecting these trajectories smoothly is performed.

FIG. 15 shows a trajectory corrected by selecting trajectories that may be subjected to smoothing using information on whether smoothing is possible, and smoothly connecting the trajectories in the joint angle space. FIG. 15 is a diagram showing the axis J1 and the axis J2 in the joint angle space as in FIG. 14. By this processing, a trajectory configured with a plurality of partial trajectories T1 to T4 passes through the via points (P2 to P4) and is smoothly connected in the joint angle space.

FIG. 16 is a diagram in which the hand trajectory in the physical space is calculated from the trajectory in the joint angle space in FIG. 15. As shown by a solid line in FIG. 16, by this processing, it is possible to obtain the trajectory smoothly connected in the physical space while passing through the input via points.

In step S105, a control time giving unit 207 respectively gives a control time 476 to each trajectory point for the trajectory data 407. The control time giving unit 207 calculates indirect angular velocity information 473 and indirect angular acceleration information 474 corresponding to the control time 476 for the trajectory data 407 to which the control time 476 is given. In order to give the control time 476, it is necessary to satisfy a limitation on a velocity or an angular velocity of each joint of the robot arm, but as an example of this method, a technique described in the following document can be applied. “Time-Optimal Parabolic Interpolation with Velocity, Acceleration, and Minimum-Switch-Time Constraints”, Puttichai Lertkultanon and Quang-Cuong Pham, Published online: 16 Jul. 2016.

In step S106, the result output unit 206 generates the Graphical User Interface (GUI) based on data stored in the storage device 120 and displays the GUI on the input and output device 140.

By the above processing, the joint angle space trajectory smoothing unit 205 introduces smoothing processing in the joint angle space for the partial trajectory between the via points, so that it is possible to minimize a change in a hand posture of the robot arm and generate the trajectory on which the robot arm can operate at a high velocity.

<Robot Arm Configuration Data>

FIG. 3 is a diagram showing an example of the robot arm configuration data 401 stored in the robot arm configuration storage unit 301. In the robot arm configuration data 401, one entry is configured with a classification 411, an item 412, and an example 413. The classification 411 includes classification of joint information and link information.

The joint information is information of respective joints constituting the robot arm, and includes information such as a joint name, a joint type, a joint position, a joint orientation, a joint operation lower limit, a joint operation upper limit, a maximum acceleration, and a maximum velocity as the item 412.

The link information is information indicating a configuration of respective links constituting the robot arm, and includes a link name, a parent joint name, a child joint name, and a link shape as the item 412. The link shape is an actual shape of the link, and is, for example, three-dimensional model data such as solid data stored in a format such as standard for the exchange of product model data (STEP) and polygon data stored in a format such as stereolithography (STL).

In the example 413, a value corresponding to each item 412 is set. The robot arm configuration data 401 can use data preset by a manufacturer of the robot arm or the like.

<Interferer Configuration Data>

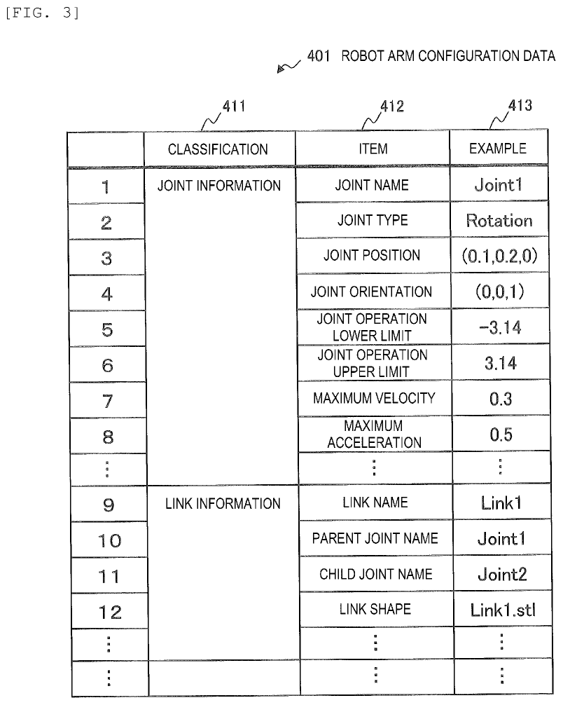

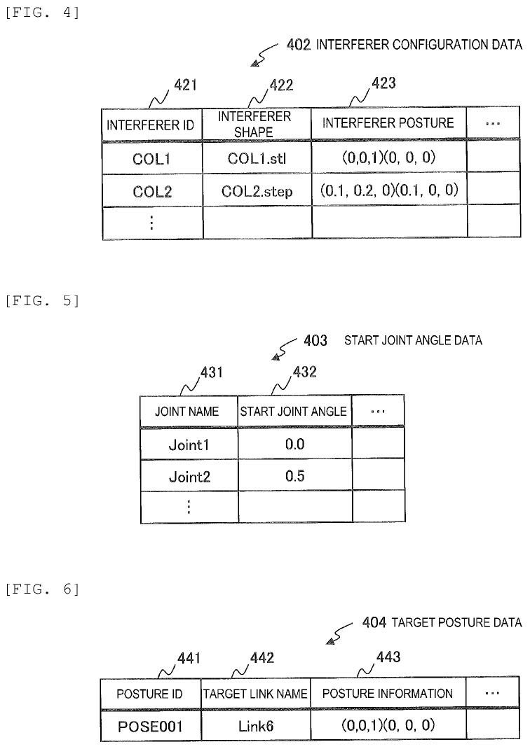

FIG. 4 is a diagram showing an example of the interferer configuration data 402 stored in the interferer configuration storage unit 302. The interferer configuration data 402 includes an interferer ID 421, an interferer shape 422, and an interferer posture 423 in one entry.

The interferer shape 422 indicates a shape of an interferer, and is, for example, the three-dimensional model data such as the solid data stored in the format such as the STEP or the polygon data stored in the format such as the STL.

The interferer posture 423 is information indicating where in the space the interferer is placed, and is information indicating a posture represented by an AFFINE transformation matrix, a position in a three-dimensional space, and Roll-Pitch-Yaw or the like. For example, in the interferer posture 423 of the interferer ID 421=“COL1”, (0, 0, 1) indicates the position, and (0, 0, 0) indicates the posture.

<Start Joint Angle Data>

FIG. 5 is a diagram showing an example of the start joint angle data 403 stored in the start joint angle storage unit 303. The start joint angle data 403 includes a joint name 431 and a start joint angle 432 in one entry.

The joint name 431 corresponds to the joint name in the joint information included in the robot arm configuration data 401. An angle of the joint is set in the start joint angle 432.

<Target Posture Data>

FIG. 6 is a diagram showing an example of the target posture data 404 stored in the target posture storage unit 304. The target posture data 404 includes a posture ID 441, a target link name 442, and posture information 443 in one entry.

In the posture ID 441, an identifier for specifying the position and the posture at the hand of the robot arm is set. The target link name 442 stores the link name in the link information included in the robot arm configuration data 401.

The posture information 443 is the information indicating the posture represented by the AFFINE transformation matrix, the position in the three-dimensional space, and the Roll-Pitch-Yaw or the like. For example, in the posture information 443 of the posture ID 441=“POSE001”, (0, 0, 1) indicates the position, and (0, 0, 0) indicates the posture.

<Via-Point Posture Data>

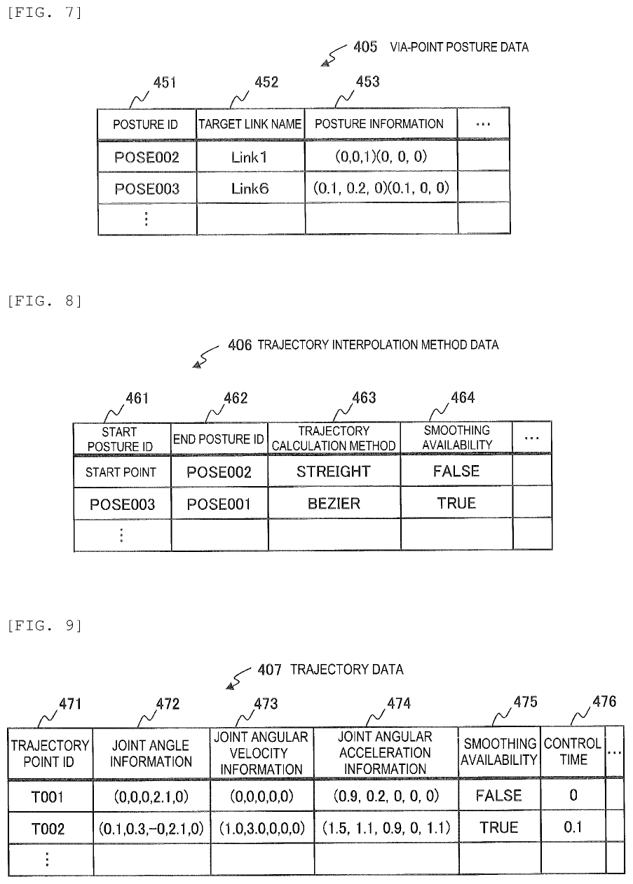

FIG. 7 is a diagram showing an example of the via-point posture data 405 stored in the via-point posture storage unit 305. The via-point posture data 405 includes a posture ID 451, a target link name 452, and posture information 453 in one entry.

In the posture ID 451, the identifier for specifying the position and the posture at the hand of the robot arm is set. The target link name 452 stores the link name in the link information included in the robot arm configuration data 401. The posture information is the information indicating the posture represented by the AFFINE transformation matrix, the position in the three-dimensional space, and the Roll-Pitch-Yaw at that time or the like. For example, in the posture information 453 of the posture ID 451=“POSE002”, (0, 0, 1) indicates the position, and (0, 0, 0) indicates the posture.

<Trajectory Interpolation Method Data>

FIG. 8 is a diagram showing an example of the trajectory interpolation method data 406 stored in the trajectory interpolation method storage unit 306. The trajectory interpolation method data 406 includes a start posture ID 461, an end posture ID 462, a trajectory calculation method 463, and smoothing availability 464 in one entry.

The start posture ID 461 and the end posture ID 462 correspond to the posture ID 451 of the via-point posture data 405 and the posture ID 441 of the target posture data 404, respectively.

The trajectory calculation method 463 stores a method of calculating (interpolating) the trajectory in the joint angle space with a partial trajectory T from the start posture ID 461 to the end posture ID 462. The calculation method includes, for example, a curve pattern such as a spline curve, a NURBS curve, and a Bezier curve, an equation representing a curve or a description specifying a straight line.

The smoothing availability 464 is a flag indicating whether the partial trajectory from the start point (start posture ID 461) to the end point (end posture ID 462) is smoothed by the joint angle.

The trajectory interpolation method data 406 is a table in which for the partial trajectory Ti configured between the via points specified by the via-point posture data 405, a method (463) of calculating the trajectory in the joint angle space and information (464) indicating whether smoothing is performed in the joint angle space are set in advance.

<Trajectory Data>

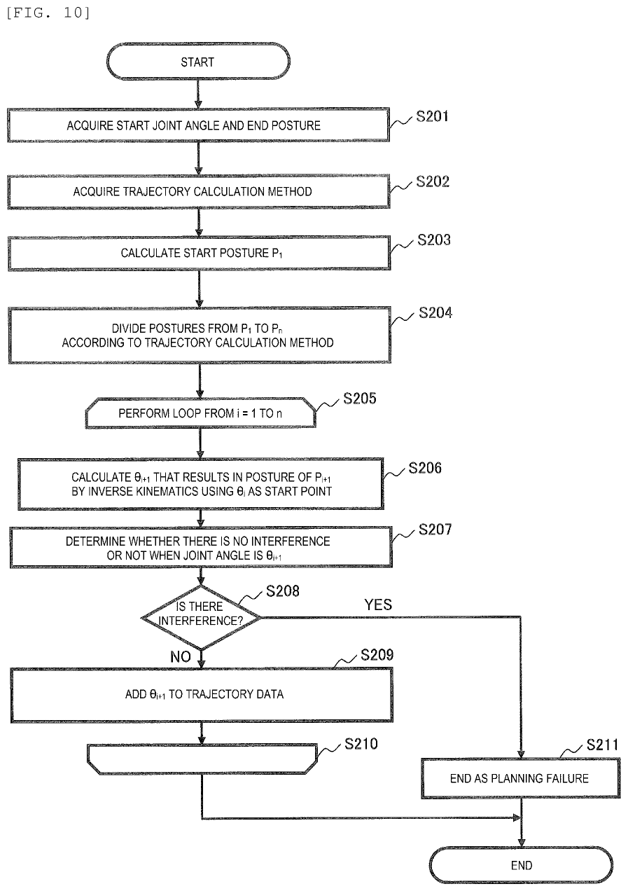

FIG. 9 is a diagram showing an example of the trajectory data 407 stored in the trajectory storage unit 307, and corresponds to an output of the trajectory planning device 100. The trajectory data 407 includes a trajectory point ID 471, joint angle information 472, joint angular velocity information 473, joint angular acceleration information 474, smoothing availability 475, and the control time 476 in one entry.

The trajectory point ID 471 stores an identifier of a position through which the hand of the robot arm passes. The joint angle information 472 is a set of joint angles at the position of the trajectory point ID 471, and is a set of joint names and joint values thereof.

Similarly, the joint angular velocity information 473 and the joint angular acceleration information 474 are information on the angular velocity and an angular acceleration at the position of the joint name and the trajectory point ID 471. The smoothing availability 475 is information used by the joint angle space trajectory smoothing unit 205, and is a flag indicating whether the joint angle information may be corrected by performing the smoothing with the joint angle. “TRUE” indicates that smoothing is possible, and “FALSE” indicates that smoothing is added.

The control time 476 stores time (relative time) at which a control of the trajectory point ID 471 calculated based on the limitation on the velocity or the limitation on an acceleration of the robot arm is performed.

<Partial Trajectory Calculation Processing>

FIG. 10 is a flowchart showing an example of the processing executed by the inter-via-point trajectory planning unit in a physical space 204 performed in step S103 of FIG. 2. Hereinafter, this flowchart will be described.

In step S201, the inter-via-point trajectory planning unit in a physical space 204 acquires a start joint angle and an end posture. The start joint angle is obtained from the joint angle information 472 corresponding to the trajectory point ID 471 added last included in the trajectory data 407.

The data input in step S101 is used as data such as a start position and an end position of the trajectory necessary for a trajectory calculation. The end posture is set from the posture information 443 of the target posture data 404.

In step S202, the inter-via-point trajectory planning unit in a physical space 204 acquires the trajectory calculation method 463 from the trajectory interpolation method data 406 corresponding to the end posture ID 462.

In step S203, the inter-via-point trajectory planning unit in a physical space 204 calculates a start posture P1 in the start joint angle data 403 of the target link name 452 as a target in the via-point posture data 405. The start posture P1 can be easily calculated by forward kinematics using the information of the robot arm configuration data 401.

In step S204, the inter-via-point trajectory planning unit in a physical space 204 divides postures from the start posture P1 to an end posture Pn according to the acquired trajectory calculation method 463 using the start posture ID 461 to the end posture ID 462 as one partial trajectory.

For convenience of description, the information about the position of the posture information is set to 0, and the information about the posture is set to Q. For example, when the straight line (Straight) is specified as the trajectory calculation method 463, the inter-via-point trajectory planning unit in a physical space 204 calculates Oi and Qi corresponding to each division point Pi from the start posture P1 to the end posture Pn as follows.

Oᵢ(1−t)O₁+tOₙ

Qᵢ=Slerp(Q₁,Qₙ,t) [Equation 1]

Here, Slerp means a spherical interpolation, and t means a value at an equal interval from 0 to 1.

When a three-dimensional Bezier curve (BEZIER) is specified as the trajectory calculation method 463, and two control points are set to A and B, Oi and Qi corresponding to each division point Pi are calculated as follows.

Oᵢ(1−t)³O₁+3t(1−t)²A+3t²(1−t)B+t³Oₙ

Qᵢ=Slerp(Q₁,Qₙ,t) [Equation 2]

By using the above equation, the inter-via-point trajectory planning unit in a physical space 204 can obtain a trajectory that moves in the physical space according to the specified method while minimizing the change in the hand posture.

In step S205, the inter-via-point trajectory planning unit in a physical space 204 executes processing from steps S206 to S210 in a loop only by the number of division points.

In step S206, the inter-via-point trajectory planning unit in a physical space 204 acquires the joint angle information 472 corresponding to the trajectory point ID 471 added last included in the trajectory data 407, and uses this joint angle as the start point to calculate a joint angle θi+1 that results in a division point posture Pi+1 using the inverse kinematics unit 203.

The processing performed by the inverse kinematics unit 203 can use, as an example, a method based on convergence calculation as described in the following document. “Solvability-unconcerned Inverse Kinematics based on Levenberg-Marquardt method with Robust Damping” (Tomomichi Sugihara, School of Information Science and Electrical Engineering, Kyushu University)

In step S207, the inter-via-point trajectory planning unit in a physical space 204 uses the joint angle θi+1 obtained in step S206, the robot arm configuration data 401, and the interferer configuration data 402 to determine whether there is any contact with the interferer at the calculated joint angle θi+1 by the interference determination unit 202.

The interference determination unit 202 determines the presence or absence of an interference based on three-dimensional model data of the robot arm configuration data 401, the position and the posture at the hand of the robot arm, and three-dimensional model data and a position of the interferer configuration data 402. Since a known or well-known technique may be applied to the determination of the interference, the determination will not be described in detail in this embodiment.

Here, the processing performed by the interference determination unit 202 not only determines whether an obstacle and the robot arm are in contact with each other, but also uses a predetermined clearance as a threshold based on a distance between the obstacle and the robot arm, and determines that there is the interfere when the clearance is smaller than the threshold.

In step S208, the inter-via-point trajectory planning unit in a physical space 204 performs processing branching based on an interference determination result in the above step S207, the processing proceeds to step S209 when there is no interference, and the processing proceeds to step S211 when there is the interference.

In step S209, the inter-via-point trajectory planning unit in a physical space 204 adds the joint angle θi+1 obtained in step S207 to the trajectory data 407 as the trajectory point ID 471, the joint angle information 472, and the smoothing availability 475. In this case, the smoothing availability 475 is set based on smoothing availability 464 included in the trajectory interpolation method data 406. The control time 476 is set in the processing of the above step S105.

In the trajectory data 407 of this embodiment, the joint angle information 472 or the like show an example of the six-axis robot arm, but the invention is not limited thereto and may have a dimension corresponding to the number of axes of the robot arm.

In step S211, when there is the interference, the inter-via-point trajectory planning unit in a physical space 204 displays information indicating that the trajectory plan is failed on the input and output device 140, and ends the processing.

By the above processing, the trajectory from the specified start position to the end position is divided into the partial trajectories from the start posture P1 to the end posture Pn, the trajectory data 407 is calculated by the trajectory calculation method 363 specified for each partial trajectory, and a joint angle θi in the physical space is determined for each trajectory point ID 471.

<Trajectory Smoothing Processing>

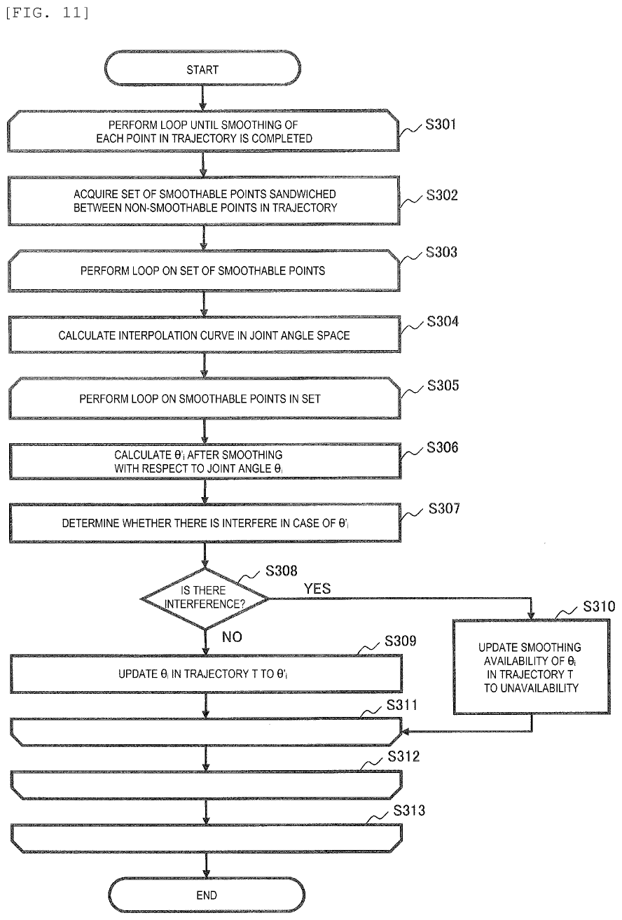

FIG. 11 is a flowchart showing an example of the trajectory smoothing processing executed by the joint angle space trajectory smoothing unit 205 in step S104 of FIG. 2.

By this processing, the joint angle information 472 in the trajectory data 407 is updated such that the robot arm operates smoothly, so that an angle change in each axis of the robot arm is reduced. Thereby, in a control time giving processing performed by the control time giving unit 207, it is easy to comply with the limitation on the angular velocity of the joint or the angular acceleration of the joint, and an operating velocity of the robot arm is improved.

At the point Pi (via point) where the partial trajectories are connected, changes (differences) of the angular velocity of the joint or the angular acceleration of the joint are matched or minimized, and a joint between the partial trajectories is smoothed. Further, the joint angular space trajectory smoothing unit 205 may match angular velocities or angular accelerations of adjacent partial trajectories at the via point (Pi) connecting adjacent partial trajectories Ti.

Hereinafter, this flowchart will be described.

In step S301, the joint angle space trajectory smoothing unit 205 performs loop processing on processing of step S302 for each trajectory point in the trajectory until smoothing is completed. This loop processing is repeated between step S301 and step S313 until the processing of each trajectory point in the trajectory is completed.

In step S302, the joint angle space trajectory smoothing unit 205 acquires, from the trajectory data 407, a set of smoothable trajectory points that are sandwiched between non-smoothable trajectory points based on the smoothing availability 475.

In step S303, the joint angle space trajectory smoothing unit 205 performs the loop processing on processing from step S304 to step S312 by the number of the set of the smoothable trajectory points that are sandwiched between the non-smoothable trajectory points acquired in step S302.

In step S304, the joint angle space trajectory smoothing unit 205 calculates an interpolation curve S in the joint angle space between the trajectory points to be smoothed based on information of the non-smoothable trajectory points sandwiching the smoothable trajectory points.

This step will be described with reference to FIG. 17. FIG. 17 is a diagram showing an example of hand trajectory points that are smoothed in the joint angle space. Joint angles at the trajectory points to be smoothed are set to θ−2 to θ to θ+2. The interpolation curve S in the figure is calculated in the joint angle space between the trajectory points to be smoothed.

Joint angles at the non-smoothable trajectory points before and after a portion to be smoothed are set to θa and θb. From this joint angle value and values of joint angles θa−1 and θb+1 before and after the joint angle, an interpolation equation F(t) that satisfies the following limitations is calculated.

F(0)=θₐ

F(1)=θ_{b}

F′(0)=θₐ−θₐ₋₁

F′(1)=θ_{b+1}−θ_{b}

F″(0)=F″(1) [Equation 3]

The above example is a limitation on the interpolation curve when sections [θa−1, θa] and [θb, θb+1] are straight lines. The method of obtaining the interpolation curve is an example, and for example, among a three-dimensional spline interpolation curve passing through joint angle values corresponding to all the non-smoothable trajectory points, those corresponding to this section may be used.

In step S305, the joint angle space trajectory smoothing unit 205 performs the loop processing for the number of the smoothable trajectory points included in the target portion in step S303. This loop processing is repeated up to step S311.

In step S306, the joint angle space trajectory smoothing unit 205 calculates a direction di that moves the trajectory point (θi) on the interpolation curve S, and calculates a new trajectory point (θ′i) moved toward di. In the following description, a trajectory point corresponding to the joint angle θi in FIG. 17 is represented by a trajectory point (θi).

Calculation results of the trajectory point (θi) and the trajectory point (θ′i) are as shown in FIG. 17. When the trajectory point (θ′i) is moved on the interpolation curve S at one time in this step, smoothing is not performed when there is the interference with the interferer at a movement destination. Therefore, it is necessary to move the trajectory point little by little. That is, the joint angle space trajectory smoothing unit 205 moves the trajectory point (θ′i) in the direction di by a predetermined distance from the trajectory point (θi), and finally moves the trajectory point (θ′i) to a trajectory point (θ′i) on the interpolation curve S.

In step S307, the joint angle space trajectory smoothing unit 205 determines whether the robot arm does not interfere with the interferer at a position of the joint angle (θ′i) to be updated using the interference determination unit 202.

In step S308, the joint angle space trajectory smoothing unit 205 branches the processing depending on the presence or absence of the interference. When there is no interference, the processing proceeds to step S309, and when there is the interference, the processing proceeds to step S310.

In step S309, the joint angle space trajectory smoothing unit 205 updates the joint angle θi of a corresponding trajectory point to θ′i.

On the other hand, in step S310, the joint angle space trajectory smoothing unit 205 changes the smoothing availability 475 for a current trajectory point to “FALSE” since the interference has occurred. That is, since the trajectory point that interferes when the robot arm is moved on the interpolation curve S becomes a new fixed point, the interpolation curve performed in a subsequent step S304 changes.

By the above processing, as shown in FIG. 17, the smoothable trajectory point (θi) sandwiched between the non-smoothable trajectory points (θa, θb) gradually moves to the trajectory point (θ′i) on the interpolation curve S while determining the interference with the interferer, and can obtain a smooth trajectory in the joint angle space.

As described above, by performing smoothing on the trajectory which is generated by the inter-via-point trajectory planning unit in a physical space 204 and converted into the joint angle space by the inverse kinematics unit 203, it is possible to prevent a sudden change or an excessive change in the angular velocity or the angular acceleration of each axis of the robot arm. Accordingly, it is possible to calculate the trajectory on which the robot arm is movable through a plurality of via points at the high velocity while minimizing the change in the hand posture of the robot arm.

<Output Screen>

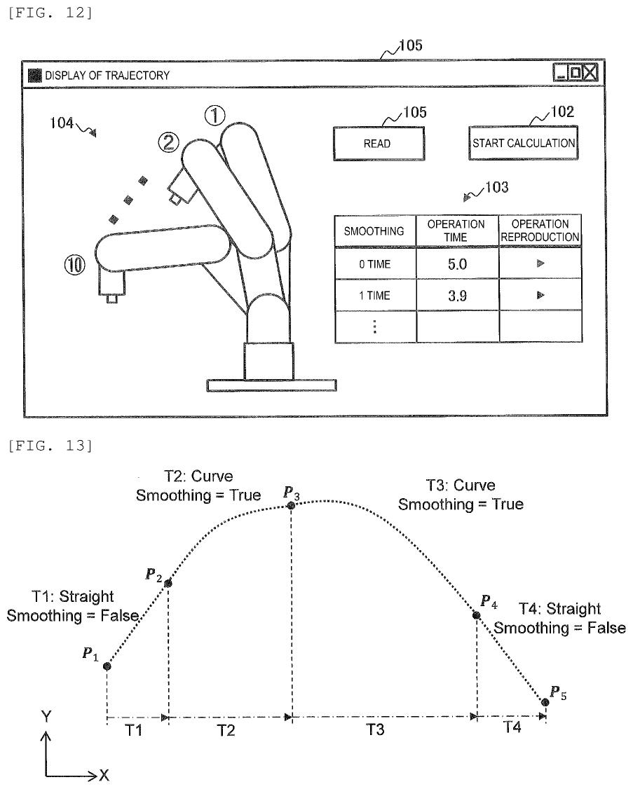

FIG. 12 is a diagram showing an example of the output screen 105 which is the output of the trajectory planning device 100. The output screen 105 includes a read button (“read” in the FIG. 101 for reading the input data, a calculation start button (“calculation start” in the FIG. 102 for executing the trajectory calculation, a table 103 showing the calculation results of the trajectory, and a simulation area 104 for displaying a movement of the robot arm.

By operating the read button 101 with a mouse or the like, the input data input via the input and output interface 130 is read into the RAM 10. By operating the calculation start button 102, the trajectory planning device 100 executes a trajectory planning calculation, and generates the simulation area 104 and table 103.

In table 103, for example, the number of times of the smoothing processing and operation time by the smoothing are displayed. By operating an operation reproduction button in the table, an operation of the robot arm can be visually recognized in the simulation area 104.

As described above, according to the system (the trajectory planning device 100 of the multi-axis robot arm), it is possible to generate a trajectory that passes through the specified via points and connects hand postures smoothly, making it easy for the robot arm to move smoothly.

### CONCLUSION

As described above, the trajectory planning device of the above embodiment can have the following configuration.

(1) A trajectory planning device (100) that includes a processor (CPU 30) and a memory (RAM 10), and calculates a hand trajectory of a robot arm configured with multiple axes, includes: robot arm configuration information (robot arm configuration data 401) including a configuration of the robot arm, and a position and a posture of an axis configuring a joint of the robot arm; start joint angle information (start joint angle data 403) in which an angle of each axis of the robot arm in a start posture of a planned trajectory is set as a start joint angle (432); target posture information (target posture data 404) in which a target position and a target posture (posture information 443) of a hand of the robot arm are set at an endpoint of the hand of the robot arm; via-point posture information (via-point posture data 405) in which via points including positions and postures through which the hand of the robot arm passes in the planned trajectory are set; an inter-via-point trajectory planning unit in a physical space (204) configured to read the robot arm configuration information (401), the start joint angle information (403), the target posture information (404) and the via-point posture information (405), and generate a trajectory from a start point of the hand of the robot arm to an end point by interpolating between the via points; an inverse kinematics unit (203) configured to calculate a joint angle of each axis from a posture and a position of the hand of the robot arm based on the robot arm configuration information (401); and a joint angle space trajectory smoothing unit (205) configured to convert the trajectory generated by the inter-via-point trajectory planning unit in a physical space (204) into a joint angle space by the inverse kinematics unit (203) and smooth the trajectory.

According to the above configuration, the trajectory planning device 100 can prevent a sudden change or an excessive change in an angular velocity or an angular acceleration of each axis of the robot arm by performing smoothing on the trajectory which is generated by the inter-via-point trajectory planning unit in a physical space 204 and converted into the joint angle space by the inverse kinematics unit 203. Accordingly, it is possible to calculate the trajectory on which the robot arm is movable through a plurality of via points at a high velocity while minimizing a change in a hand posture of the robot arm.

(2) The trajectory planning device according to the above (1) further includes a trajectory time giving unit (207) configured to give a time of passing through the via points of the trajectory to the trajectory smoothed by the joint angle space trajectory smoothing unit (205).

According to the above configuration, since the change in the hand posture of the robot arm can be minimized, the trajectory planning device 100 can calculate a smooth trajectory that satisfies a limitation on the velocity (angular velocity) or the acceleration (angular acceleration) of the robot arm.

(3) The trajectory planning device (100) according to the above (1) further includes smoothing availability information (464) configured to indicate whether smoothing is possible in a partial trajectory which is regarded as the partial trajectory between adjacent via points, and trajectory interpolation information (trajectory interpolation method data 406) configured to set an interpolation method (463) when performing the smoothing, in which the joint angle space trajectory smoothing unit (205) complements the trajectory based on the interpolation method when smoothing availability information (475) of the partial trajectory of an object calculating the trajectory is possible with reference to the trajectory interpolation information (406).

According to the above configuration, in the partial trajectory for which smoothing availability 475 is “possible”, the smoothing in the joint angle space is performed by a specified trajectory calculation method 363. Accordingly, the trajectory planning device 100 can calculate the trajectory on which the robot arm is movable through the plurality of via points at the high velocity while minimizing the change in the hand posture of the robot arm.

(4) In the trajectory planning device (100) according to the above (1), the robot arm configuration information (401) includes three-dimensional model information of the robot arm, and the trajectory planning device further includes interferer configuration information (402) including three-dimensional model information and a position of an interferer disposed around the robot arm, and an interference determination unit (202) configured to determine whether the robot arm interferes with the interferer with reference to the robot arm configuration information (401) and the interferer configuration information (402) for the trajectory calculated by the inter-via-point trajectory planning unit in a physical space (204) or the joint angle space trajectory smoothing unit (205).

According to the above configuration, the trajectory planning device 100 can calculate a smooth trajectory while avoiding a trajectory where the robot arm interferes with the interferer.

(5) The trajectory planning device (100) according to the above (2) further includes smoothing availability information (475) configured to indicate whether smoothing is possible in a partial trajectory which is regarded as the partial trajectory between adjacent via points, and trajectory interpolation information (406) configured to set an interpolation method when performing the smoothing, and the trajectory time giving unit (207) configured to match the velocities or the angle accelerations of adjacent partial trajectories in the via points of the adjacent partial trajectories.

According to the above configuration, in the trajectory planning device 100, at a point Pi (via point) where the partial trajectories are connected, changes of the angular velocity or the angular acceleration of the robot arm are matched or minimized, a joint between the partial trajectories is smoothed, and a smooth operation of the robot arm can be realized.

The invention is not limited to the embodiments, and includes various modifications. For example, the above embodiments have been described in detail for easy understanding of the invention, and the invention is not necessarily limited to those including all the configurations described. In addition, a part of the configuration of one embodiment can be replaced with the configuration of another embodiment, and the configuration of another embodiment can be added to the configuration of one embodiment. A part of the configuration of each embodiment may be subjected to addition, deletion and replacement of another configuration.

Each of the configurations, functions, processing units, processing methods or the like described above may be partially or entirely implemented by hardware such as through design using an integrated circuit. Each of the configurations, functions, or the like described above may be implemented by software by interpreting and executing a program for implementing respective functions by the processor. Information such as a program, a table, a file, or the like for implementing the respective functions can be stored in a recording apparatus such as a memory, a hard disk, or a solid state drive (SSD), or in a recording medium such as an IC card, an SD card, or a DVD.

Control lines or information lines indicate what is considered necessary for explanation, and do not indicate all the control lines or information lines in a product. It may be considered that almost all the configurations are actually connected to each other.

### REFERENCE SIGN LIST

100 trajectory planning device
110 processing device
120 storage device
130 input and output interface
140 input and output device
201 data reading unit
202 interference determination unit
203 inverse kinematics unit
204 inter-via-point trajectory planning unit in physical space
205 joint angle space trajectory smoothing unit
206 result output unit
207 control time giving unit
301 robot arm configuration storage unit
302 interference configuration storage unit
303 start joint angle storage unit
304 target posture storage unit
305 via-point posture storage unit
306 trajectory interpolation method storage unit
307 trajectory storage unit

1. A trajectory planning device that includes a processor and a memory, and calculates a hand trajectory of a robot arm configured with multiple axes, the trajectory planning device comprising:
robot arm configuration information including a configuration of the robot arm, and a position and a posture of an axis configuring a joint of the robot arm;
start joint angle information in which an angle of each axis of the robot arm in a start posture of a planned trajectory is set as a start joint angle;
target posture information in which a target position and a target posture of a hand of the robot arm are set at an end point of the hand of the robot arm;
via-point posture information in which via points including positions and postures through which the hand of the robot arm passes in the planned trajectory are set;
an inter-via-point trajectory planning unit in a physical space configured to read the robot arm configuration information, the start joint angle information, the target posture information and the via-point posture information, and generate a trajectory from a start point of the hand of the robot arm to the end point by interpolating between the via points;
an inverse kinematics unit configured to calculate a joint angle of each axis from a posture and a position of the hand of the robot arm based on the robot arm configuration information; and
a joint angle space trajectory smoothing unit configured to convert the trajectory generated by the inter-via-point trajectory planning unit in a physical space into a joint angle space by the inverse kinematics unit and smooth the trajectory.

2. The trajectory planning device according to claim 1, further comprising:
a trajectory time giving unit configured to give a time of passing through the via points of the trajectory to the trajectory smoothed by the joint angle space trajectory smoothing unit.

3. The trajectory planning device according to claim 1, further comprising:
smoothing availability information configured to indicate whether smoothing is possible in a partial trajectory which is regarded as the partial trajectory between adjacent via points; and trajectory interpolation information configured to set an interpolation method when performing the smoothing, wherein
the joint angle space trajectory smoothing unit is configured to complement the trajectory based on the interpolation method when the smoothing availability information of the partial trajectory of an object calculating the trajectory is possible with reference to the trajectory interpolation information.

4. The trajectory planning device according to claim 1, wherein
the robot arm configuration information includes three-dimensional model information of the robot arm, and
the trajectory planning device further includes:
interferer configuration information including three-dimensional model information and a position of an interferer disposed around the robot arm; and
an interference determination unit configured to determine whether the robot arm interferes with the interferer with reference to the robot arm configuration information and the interferer configuration information for the trajectory calculated by the inter-via-point trajectory planning unit in a physical space or the joint angle space trajectory smoothing unit.

5. The trajectory planning device according to claim 2, further comprising:
smoothing availability information configured to indicate whether smoothing is possible in a partial trajectory which is regarded as the partial trajectory between adjacent via points; and trajectory interpolation information that sets an interpolation method when performing the smoothing, wherein
the trajectory time giving unit matches velocities or accelerations of adjacent partial trajectories in the via points of the adjacent partial trajectories.

6. A trajectory planning method in which a trajectory planning device including a processor and a memory calculates a hand trajectory of a robot arm configured with multiple axes, the trajectory planning method comprising:
a physical space trajectory planning step in which the trajectory planning device is configured to read robot arm configuration information including a configuration of the robot arm, and a position and a posture of an axis configuring a joint of the robot arm, start joint angle information in which an angle of each axis of the robot arm in a start posture of a planned trajectory is set as a start joint angle, target posture information in which a target position and a target posture of a hand of the robot arm are set at an end point of the hand of the robot arm, and via-point posture information in which via points including positions and postures through which the hand of the robot arm passes in the planned trajectory are set, and generate a trajectory from a start point of the hand of the robot arm to the end point by interpolating between the via points;
an inverse kinematics step in which the trajectory planning device configured to calculate a joint angle of each axis from a posture and a position of the hand of the robot arm for the generated trajectory with reference to the robot arm configuration information, and convert the trajectory into a joint angle space; and
a joint angle space smoothing step in which the trajectory planning device is configured to smooth the trajectory converted into the joint angle space.

7. The trajectory planning method according to claim 6, further comprising:
a trajectory time giving step in which the trajectory planning device is configured to give a time of passing through the via points of the trajectory to the trajectory smoothed by the joint angle space smoothing step.

8. The trajectory planning method according to claim 6, wherein
the joint angle space smoothing step reads smoothing availability information indicating whether smoothing is possible in a partial trajectory which is regarded as the partial trajectory between adjacent via points and trajectory interpolation information that sets an interpolation method when performing the smoothing, and complements the trajectory based on the interpolation method when the smoothing availability information of the partial trajectory of an object calculating the trajectory is possible.

9. The trajectory planning method according to claim 6, wherein
the robot arm configuration information includes three-dimensional model information of the robot arm, and
the trajectory planning method further includes:
an interference determination step in which the trajectory planning device reads interferer configuration information including three-dimensional model information and a position of an interferer disposed around the robot arm, and determines whether the robot arm interferes with the interferer based on the robot arm configuration information and the interferer configuration information for the trajectory calculated in the physical space trajectory planning step or the joint angle space smoothing step.

10. The trajectory planning method according to claim 7, wherein
the trajectory time giving step reads smoothing availability information indicating whether smoothing is possible in a partial trajectory which is regarded as the partial trajectory between adjacent via points and trajectory interpolation information that sets an interpolation method when performing the smoothing, and matches velocities or accelerations of adjacent partial trajectories in the via points of the adjacent partial trajectories.

11. A program for calculating a hand trajectory of a robot arm configured with multiple axes in a computer including a processor and a memory, the program causing the computer to execute:
a physical space trajectory planning step of reading robot arm configuration information including a configuration of the robot arm, and a position and a posture of an axis configuring a joint of the robot arm, start joint angle information in which an angle of each axis of the robot arm in a start posture of a planned trajectory is set as a start joint angle, target posture information in which a target position and a target posture of a hand of the robot arm are set at an endpoint of the hand of the robot arm, and via-point posture information in which via points including positions and postures through which the hand of the robot arm passes in the planned trajectory are set, and generating a trajectory from a start point of the hand of the robot arm to the endpoint by interpolating between the via points;
an inverse kinematics step of calculating a joint angle of each axis from a posture and a position of the hand of the robot arm for the generated trajectory with reference to the robot arm configuration information, and converting the trajectory into a joint angle space; and
a joint angle space smoothing step of smoothing the trajectory converted into the joint angle space.
